(19) United States
(12) Patent Application Publication
(10) Pub. No.: US 2011/0278412 A1
(43) Pub. Date: Nov. 17, 2011

(54) Reversible Keyboard Support

(76) Inventors: Alan Craig Barts, Newport, NC (US); William Deruise, Newport, NC (US); Jesse Wayne Willis, Beaufort, NC (US)

(21) Appl. No.: 13/108,907

(22) Filed: May 16, 2011

Related U.S. Application Data
(60) Provisional application No. 61/395,732, filed on May 17, 2010.

(51) Int. Cl. A47B 81/00; B23P 11/00

(52) U.S. Cl. 248/274.1; 29/428

(57) ABSTRACT

A keyboard support device having a generally planar support platform including a first keyboard support surface and an opposing second keyboard support surface. The platform includes two side edges and two end edges. Riser elements are formed along each end of the platform. The riser elements may be integrally formed or be formed as attachments. Preferably, the risers are integrally formed and the transition zone between the platform and each riser is formed as a smooth curve for additional wrist comfort experienced by users. The risers are directed oppositely from one another. That is, a first riser element is directed in a first direction and a second riser element is directed at a second direction different from the first direction and preferably oppositely from the first direction such that the riser elements extend in parallel but project oppositely away from their respective ends of the platform.

### CROSS-REFERENCE TO RELATED APPLICATION

The present application claims the benefit of U.S. Provisional Application Ser. No. 61/395,732, filed May 17, 2010.

### BACKGROUND OF THE INVENTION

The present invention relates broadly to computer accessories and more particularly to a reversible keyboard support device, which may be formed as a tray, providing a keyboard position forming an angle of depression with a horizontal line generally through a predetermined portion of the keyboard support device of the present invention.

Keyboard usage can put a strain on the wrists of keyboard users with most keyboards disposed at an angle extending upwardly from the support surface of the keyboard. Such a wrist angle bends a user's hands backwardly and provides an unnatural wrist position. After weeks, months and years of keyboard use in such an unnatural position, medical problems such as carpal tunnel syndrome can develop. Such medical problems can be debilitating.

Most keyboard support devices assist the legs of the keyboard by propping up an upper portion of the keyboard at an angle rising from the horizontal. Further, slide out keyboard trays that attach to desks typically provide a low keyboard position with the unnatural wrist angle, therefore creating a situation where wrist injury can occur.

If a person extends their arms normally and lets their hands hang free, the hand typically drops to an angle of depression with a horizontal line defined by the arms. Such an angle may amount to 15 to 30 degrees depressed from the horizontal. It would be therefore beneficial to have a keyboard support structure which would provide a more natural hand angle for use of the keyboard by providing an angel of depression rather than a rising angle with respect to an axis defined by the arms of a user.

### SUMMARY OF THE INVENTION

It is accordingly an object of the present invention to provide a keyboard support device which is reversible and can provide a selective one of at least two angles of depression for keyboard positioning.

The present invention is directed to a keyboard support device having a generally planar support platform including a first keyboard support surface and an opposing second keyboard support surface. The platform includes two side edges and two end edges. The platform may be 10-12 inches deep and approximately 20-24 inches wide, or as wide as necessary to accommodate a keyboard or other key-based manual computer input or computer control device. Further, the platform may be sized to accommodate calculators, netbooks, notebook computers, tablet computers, smartphones, or other hand-operable instruments, including control devices such as mice and track balls. In addition, the present invention may be sized to accommodate musical keyboards and in general its benefits may be realized by users of operating devices, apparatus or the like that require manual activation of keys, switches or the like, especially when the user is seated with arms at least partially extended.

The present invention is directed to a keyboard support device having a body, the body being formed with a first keyboard support surface and a second keyboard support surface disposed oppositely from the first keyboard support surface, and including a pair of elongate edges including a first elongate edge formed along the body and a second elongate edge formed along the body at a disposition oppositely from the first edge. A first riser element is operatively associated with the first elongate edge and projecting outwardly therefrom in a first direction for selective device support surface engagement to present the first keyboard support surface for use. A second riser element is operatively associated with the second elongate edge and projecting outwardly therefrom in a second direction, the second direction being different from the first direction, for selective device support surface engagement to present the second keyboard support surface for use, wherein at least one of the first keyboard support surface and the second keyboard support surface extends at an angle of depression with respect to a horizontal plane extending tangentially to the upwardmost projection of one of the first keyboard support surface and the second keyboard support surface when the device is disposed on the device support surface for use.

The riser elements are formed along each end of the platform. The riser elements may be integrally formed or be formed as attachments. Preferably, the risers are integrally formed and the transition zone between the platform and each riser is formed as a smooth curve for additional wrist comfort experienced by users. The risers are disposed substantially oppositely from one another. That is, a first riser element is directed in a first direction and a second riser element is directed at a second direction different from the first direction and preferably oppositely from the first direction such that the riser elements extend in an approximately parallel relationship, but project oppositely away from their respective ends of the platform. Therefore, when a keyboard is disposed on the platform the bottom portion of the keyboard is elevated by one or the other of the riser elements.

As will be seen in greater detail hereinafter, the support device of the present invention is reversible in that the entire device may be placed to achieve a first operating position then inverted and placed again to achieve a second operating position different from the first operating position.

It should be noted that in discussing a keyboard, reference to the bottom portion or the top portion is herein meant to refer to the useful face of the keyboard wherein the spacebar is at the bottom portion and the numbers are across the top portion. The underside of the keyboard is meant to address the portion of the keyboard that supports the keyboard on a surface and from wherein the extendable feet project. Typically, on a keyboard, the extendable feet will project from the underside of the keyboard nearest the top to provide a rising slope to the keyboard on a generally horizontally oriented support surface. The configuration of the present invention presents the keyboard at a predetermined angle of depression so that the wrists of the user may be positioned in a natural manner during keyboard operation.

The riser elements are of different lengths to thereby provide different angles of depression when the keyboard tray is in use at a selected one of the two operational positions. A short first riser of approximately 1.25 inches with a platform depth of about 10 inches provides an angle of depression of approximately 7 degrees while the larger riser with a height of about 2.25 inches with 10 inch platform depth provides an angle of depression of approximately 13 degrees. It is contemplated that the risers may be formed from different lengths to provide different angles of depression of between approximately 5 degrees and 20 degrees as suits a particular user. The risers may each be formed as a continuous panel, extending the full width of the support platform. or the risers may be formed as legs, extending from the platform along the edges thereof.

Preferably, the keyboard support device includes at least one of the first riser element and the second riser element being integrally formed with the body along at least one of the first edge and the second edge. It is further preferred that at least one of the first riser element and the second riser element is integrally formed with the body along at least one of the first edge and the second edge thereby forming at least one of a first transition portion and a second transition portion. The first riser element and the second riser element may extend in substantially opposite directions and extend in a generally parallel orientation.

It is also preferred that the first riser element extend away from the body in a first angular relationship therewith and the second riser element extend away from the body in a second angular relationship therewith, the first angular relationship being substantially similar with the second angular relationship. On the other hand, the first riser element may extend away from the body in a first angular relationship therewith and the second riser element may extend away from the body in a second angular relationship therewith, the first angular relationship being substantially different from the second angular relationship.

Preferably, the first riser element extends away from the body for a first predetermined length and the second riser element extends away from the body for a second predetermined length, the first predetermined length being the same as the second predetermined length. Alternately, the first riser element may extend away from the body for a first predetermined length and the second riser element may extend away from the body for a second predetermined length, the first predetermined length being different from the second predetermined length.

When in use, one riser element provides support for the portion of the tray that accommodates the bottom portion of the keyboard while the platform portion adjacent the curved transition portion associated with the other riser element provides support for the top portion of the keyboard disposed on the present tray. While not impossible, it is nevertheless noted that the present invention is not useful in a configuration wherein the keyboard is reversed in order to use the device of the present invention to provide a rising-angle keyboard support.

According to the method of the present invention, a control device may be supported using the steps of:
using a support device having a body, the body being formed with a first support surface and a second support surface disposed oppositely from the first support surface, and including a pair of elongate edges including a first elongate edge formed along one side of the body and a second elongate edge formed along the body at a disposition oppositely from the first edge; a first upstanding support bar operatively associated with the first elongate edge and projecting outwardly therefrom in a first direction for selective support surface engagement to present the first support surface for use; and a second upstanding support bar operatively associated with the second elongate edge and projecting outwardly therefrom in a second direction, the second direction being different from the first direction, for selective support surface engagement to present the second support surface for use, stand the body on a support surface, wherein the first keyboard support surface and the second keyboard support surface extend at an angle of depression with a horizontal plane extending tangentially to the upwardmost projection of one of the first keyboard support surface and the second keyboard support surface when the device is disposed on the support surface for use; and
placing the computer input device on one of the first support surface and the second support surface for positioning the control device at a first selected disposition for use thereof.
   The method further preferably comprises the steps of:
removing the control device from at least one of the first support surface and the second support surface using a support device wherein the first upstanding support bar extends away from the body in a first angular relationship therewith and the second upstanding support bar extends away from the body in a second angular relationship therewith, the first angular relationship being substantially different from the second angular relationship;
inverting the support device to present the other of the first support surface and the second support surface for use; and
placing the control device on the other of the first support surface and the second support surface for positioning the control device at a second selected disposition for use thereof.
   The method also preferably includes the steps of:
removing the control device from at least one of the first support surface and the second support surface using a support device wherein the first upstanding support bar extends away from the body for a first predetermined length and the second upstanding support bar extends away from the body for a second predetermined length, the first predetermined length being different from the second predetermined length;
inverting the support device to present the other of the first support surface and the second support surface for use; and
placing the control device on the other of the first support surface and the second support surface for positioning the control device at a second selected disposition for use thereof.

It is preferable that feet be placed along the flat riser element support surfaces for enhanced stability during use. It is further preferred that the device be formed from Plexiglas which may be formed in a variety of different colors. It is further preferred that at least one riser element be formed as an indicia-carrying element or indicia carriers so that sponsorship or fan support may be expressed by using the keyboard support device of the present invention.

By the above, the present invention provides an ergonomic, simple device which can provide enhanced comfort for users of keyboards or other manually operated devices.

### BRIEF DESCRIPTION OF THE DRAWINGS

FIG. 1 is a perspective view of a keyboard support device according to one preferred embodiment of the present invention in an environmental view;

FIG. 2 is a perspective view of the keyboard support device illustrated in FIG. 1 at a first usage position;

FIG. 3 is a side view of the keyboard support device illustrated in FIG. 2;

FIG. 4 is a perspective view of the keyboard support device illustrated in FIG. 1 at a second usage position;

FIG. 5 is a side view of the keyboard support device illustrated in FIG. 4;

FIG. 6 is a perspective view of a second preferred embodiment of the keyboard support device of the present invention;

FIG. 7 is a perspective view of the keyboard support device illustrated in FIG. 6 shown at a second usage position;

FIG. 8 is a close up side view of a first riser element of the keyboard support device of the present invention;

FIG. 9 is a side view of another riser element according to one preferred embodiment of the present invention; and

FIG. 10 is a perspective view of a third preferred embodiment of the present invention.

### DESCRIPTION OF THE PREFERRED EMBODIMENT

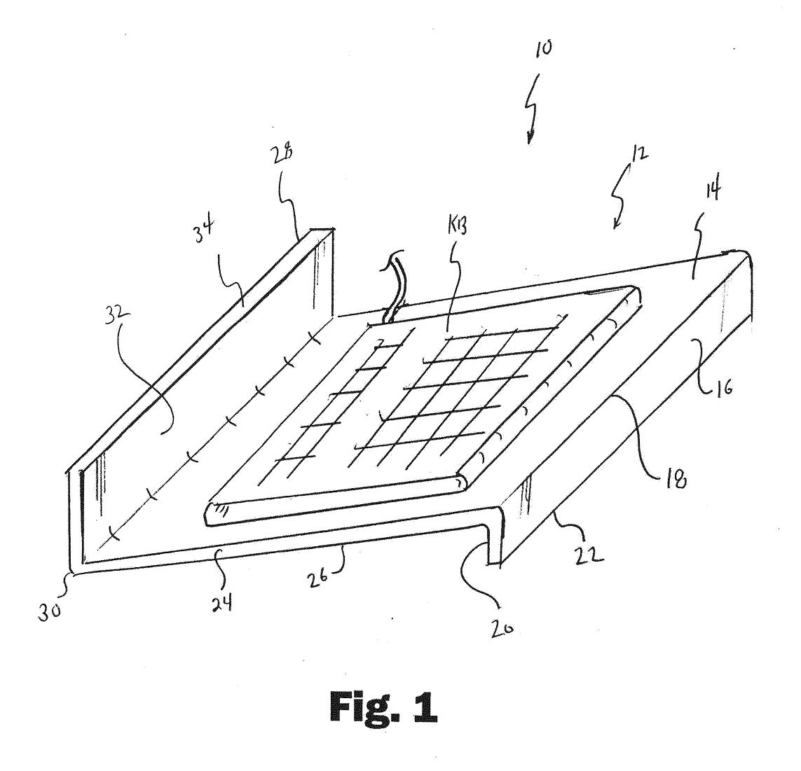

Turning now to the drawings and more particularly to FIG. 1, a keyboard support device according to a first preferred embodiment of the present invention is illustrated generally at 10 and includes a body 12 for keyboard support. The body 12 includes a first keyboard support surface 14 in opposition with a second keyboard support surface 26. A first riser element 16 extends generally perpendicularly away from one end of the first keyboard support platform 14. A second riser element 28 extends outwardly from the opposite end of the keyboard support platform 14. Side edges 24 extend between the riser support surfaces 22, 34.

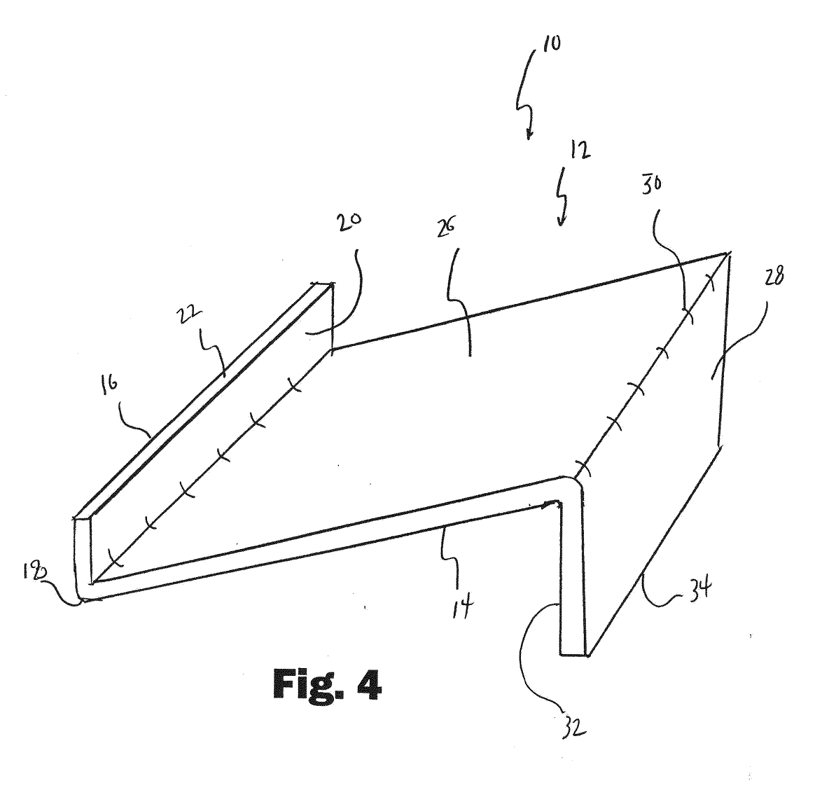

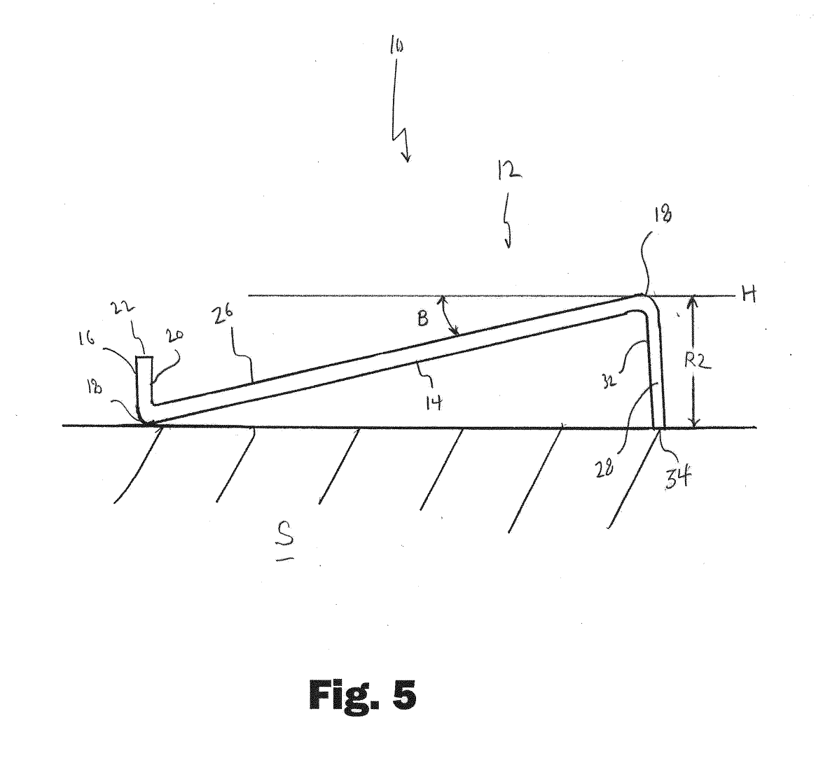

In a first orientation, as seen in FIGS. 1-3, the first riser element 16 extends in a first direction different from and, preferably, generally oppositely from the second keyboard riser element 28 with the first keyboard support surface 14 in contact with an upper portion of the first riser element 16 and in contact with a lower portion of the second riser element 28 to extend diagonally between the riser elements. In a second orientation, as seen in FIGS. 4-5, the first riser element 16 extends in a first direction different from and, preferably, generally oppositely from the second riser element 28 with the second keyboard support surface 26 in contact with an upper portion of the second riser element 28 and in contact with a lower portion of the first riser element 16 to extend diagonally between the riser elements.

The first riser element 16 is shorter than the second riser element 28. Therefore when a respective one of the keyboard support surfaces 14, 26 is directed upwardly, one of the risers 16, 28 will be directed downwardly to provide a downwardly sloping, that is at an angle depressed from the horizontal, keyboard support surface 14, 26 with the other riser element 16, 28 acting as a backstop 20, 32 to keep the keyboard from sliding off the support device 14, 26.

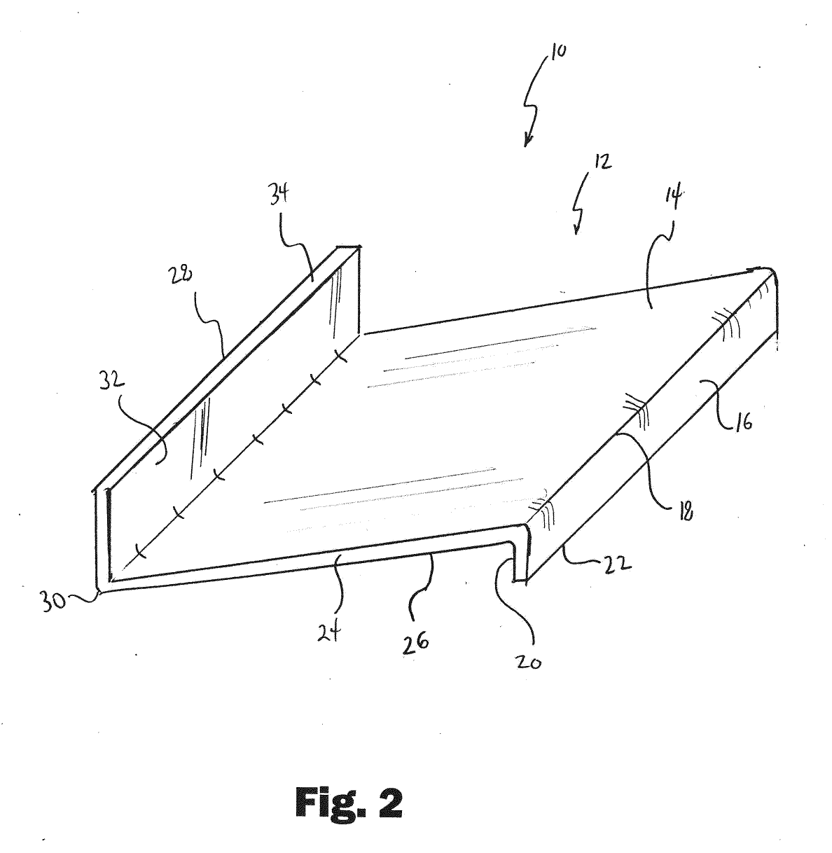

As seen in FIGS. 1 and 2, the present keyboard support device 10 includes a curved first junction region 18 forming a boundary between the first riser element 16 and the first keyboard support surface 14. The smooth curvature of the first junction region 18 provides an ergonomic transition zone for the wrist of a user to rest as the hands project at an angle of depression with the horizontal plane defined by the arms.

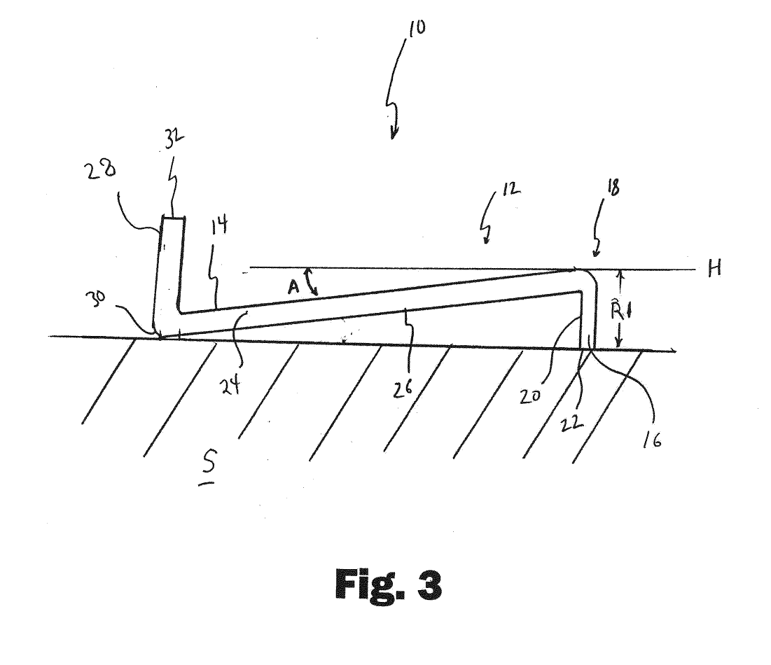

Turning now to FIG. 3, a side view of the keyboard support device 10 shown in FIGS. 1 and 2 illustrates the angle of depression A attained by using the keyboard support device 10 of the present invention in a first position using the first riser 16 to elevate the bottom of the keyboard on the support platform with respect to the top of the keyboard on the support platform. In FIG. 3, the horizontal is represented by a horizontal axis H forming an angle of depression A with the keyboard support surface 14. The first riser element height is represented by R1 in FIG. 3 and if R1 equals 1.25 inches, angle A equals approximately 7 degrees. Due to the thickness of the integrally formed keyboard support device 10 illustrated by side edge 24 in combination with the smooth first junction region 18 of the transition area extending between the first keyboard support surface 14 and the first riser element 16, the angle shown is an approximation that is calculated based on a right triangle formed by the first riser element 16 and the horizontal axis H.

Turning now to FIG. 4 and FIG. 5, the keyboard support device 10 of the present invention is shown inverted with respect to its position in FIGS. 1, 2 and 3. The inversion capability of the present invention allows the user a choice of depression angles, based on the respective heights R1, R2 of the riser elements 16, 28 to provide whichever angle is more comfortable. As seen in FIG. 4, the second riser element 28 is integrally formed with the second keyboard support surface 26 and a curved second junction portion 30 extends along a border area or region between the second riser element 28 and the second keyboard support surface 26. The first riser element 16 therefore forms a backstop 20 and rests on the curved first junction portion 18 to provide support for the keyboard device 10 of the present invention.

As seen in FIG. 5, the horizontal axis is represented at H and the second riser element 28 height is represented by R2. The resultant angle B is on the order of 13 degrees based on an R2 value of 2.25 inches. It should be noted that a depression angle of between about 7 and about 20 degrees can be considered useful with the present invention and the angle of depression may be chosen and based on the height of the riser elements 16, 28. The foregoing presumes a first riser height of 1.25 inches and a second riser height of 2.25 inches. The calculation gives a first depression angle A of 7 degrees and a second depression angle B of approximately 13 degrees. In FIG. 5, the keyboard support device 10 is shown resting on a support surface S with one end supported by the distal edge of the first riser element 34 and the curved region 18 of the first riser element 16 junction with the first keyboard support surface 14. FIGS. 4 and 5 illustrate the versatility of the keyboard support device of the present invention to provide two selective angles of depression from a single rigid molded device to accommodate the needs of users.

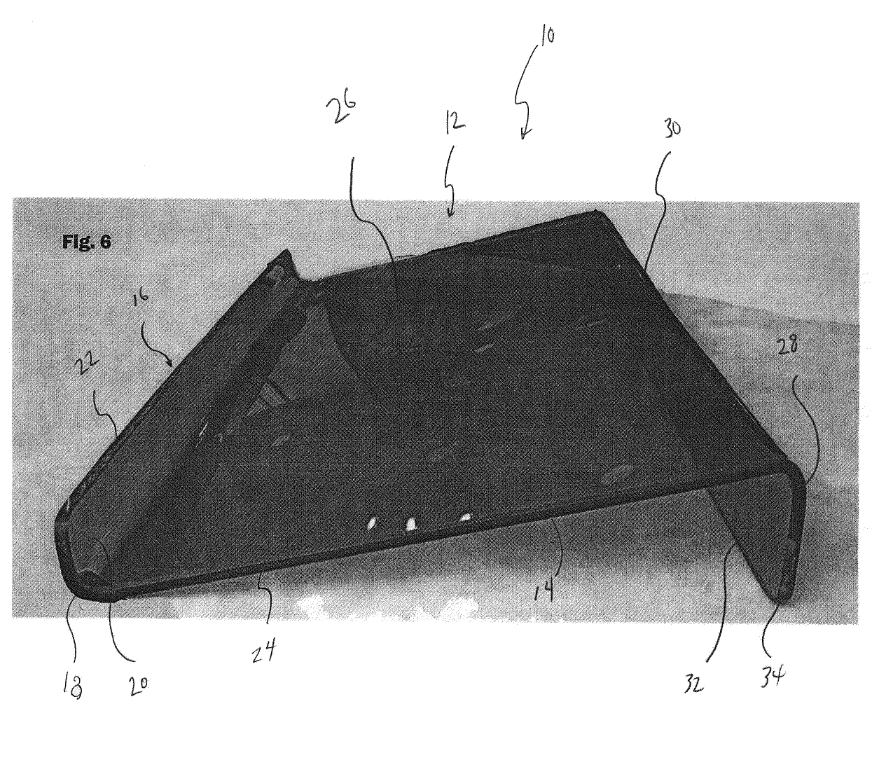

As seen in FIG. 6, the present keyboard support device 12 may be formed integrally from a Plexiglas-type structure or other plastic. The support device 10 at FIG. 6 is formed from a smoked Plexiglas material that is bent at each end to form the riser elements 16, 28. As can be seen, the curved regions 18, 30 provide smooth transitions between the vertically arranged riser element 16, 28 and the planar support surfaces 14, 26 extending at the respective angles of depression when the respective risers and curved regions are disposed on a support surface.

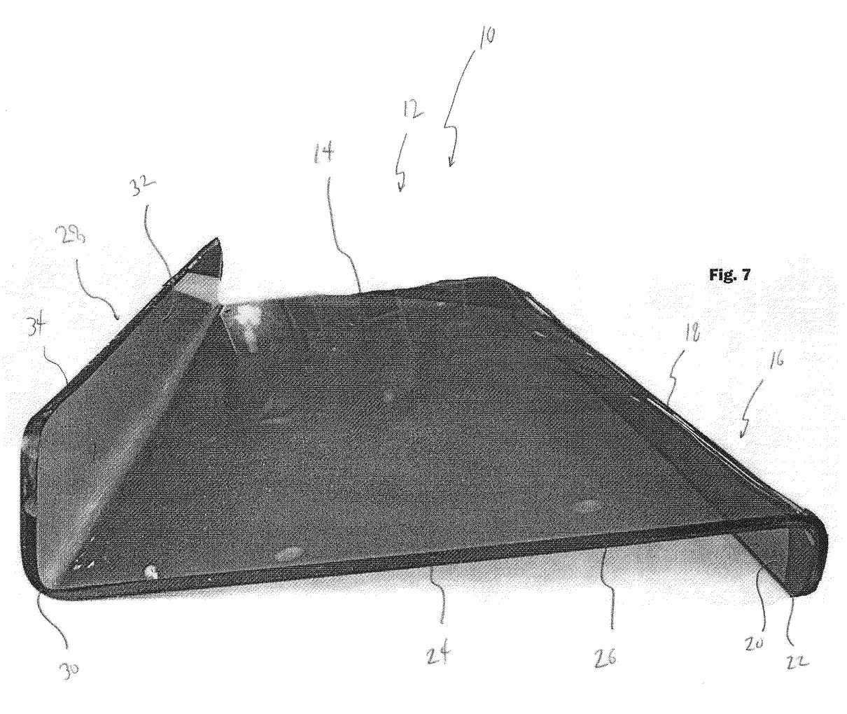

FIG. 7 illustrates the keyboard support device 10 of the present invention inverted from its position in FIG. 6 thereby providing a shallower angle of depression than that provided in FIG. 6.

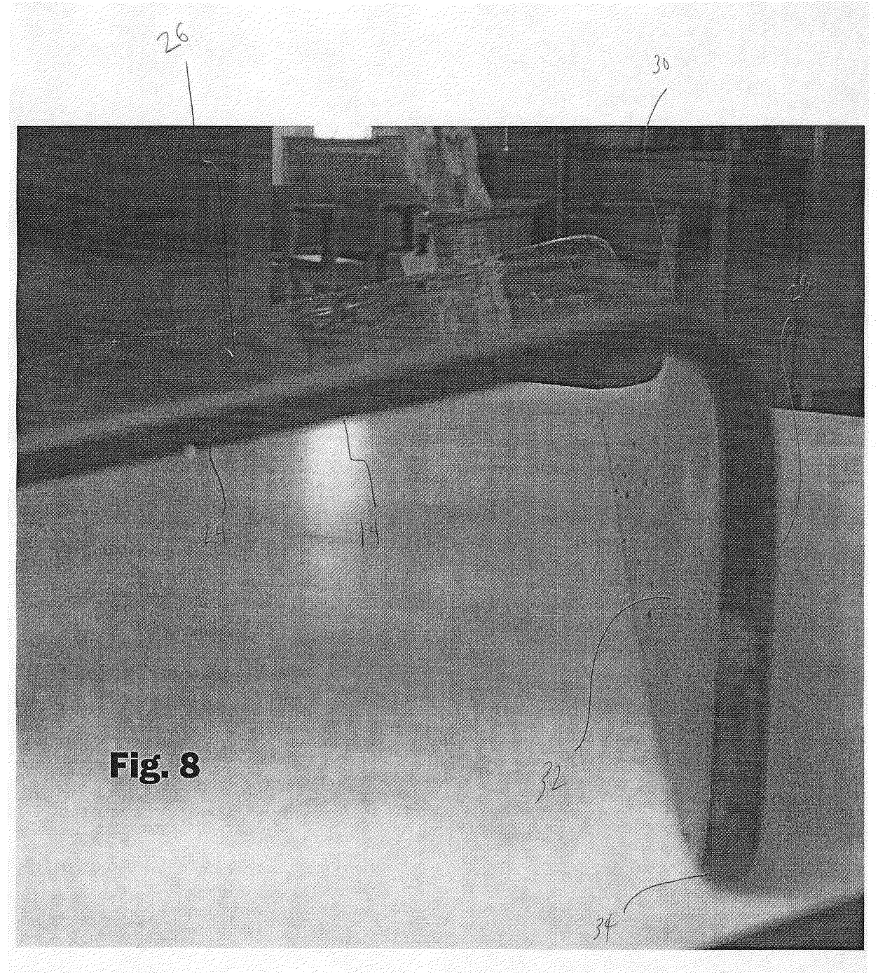

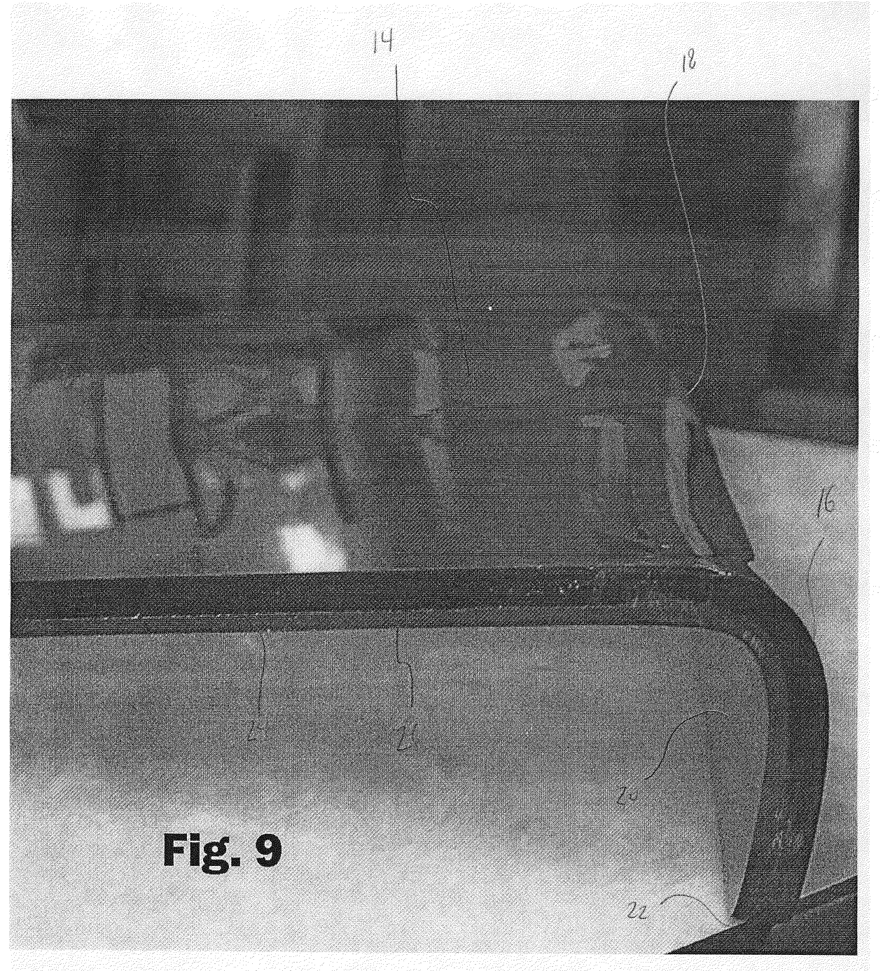

FIGS. 8 and 9 illustrate an optional feature wherein that the riser elements 16, 28 curve inward slightly after turning downward from the support surfaces 14, 26. As seen in FIG. 8, the second riser element 28 curves slightly inwardly from its generally vertical extent while supporting the keyboard support device on its distal edge 34.

Similarly, the first riser element 16 is curved slightly inwardly to allow the keyboard support device 10 to rest on the distal edge 22 of the first riser element 16. The inward curvature allows the footprint of the keyboard support device 10 to be adjustable during manufacture such that the slight variances in footprint of the device due to dissimilar distances between strictly vertical first and second risers is substantially similar and the distance between the risers and the curved regions on both sides is uniform. Therefore, if the present keyboard support device 10 was supported in a shallow well or other indentation configured to receive such a support device, it can be fitted snuggly within such a positioning structure equally no matter which side or which support surface, 14, 26 was chosen based on the desired angle of depression of the keyboard in light of the user's preferences.

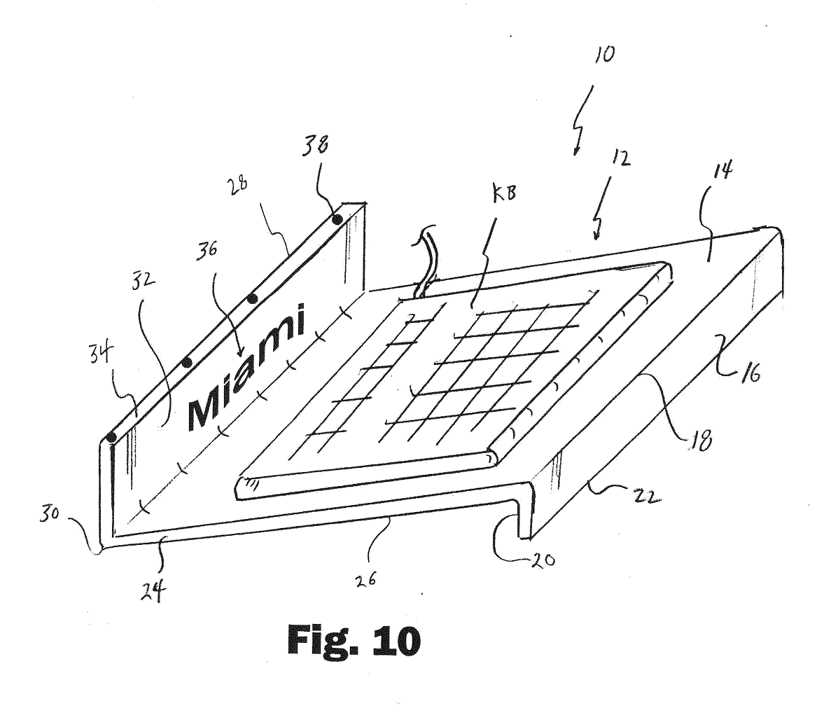

Referring now to FIG. 10, other options to the keyboard support device 10 of the present invention include feet 38 which may be felt pads, rubber pads or other foot-type elements extending along the distal edge 34 of the second riser 28 in FIG. 10 and the feet should be placed on the distal edge 22 of the first riser 16 so that the tray will perform similarly with either keyboard support surface 14, 26 in use.

It is also contemplated that the backstop areas 32, 20 of the respective riser elements 16, 28 be used as an indicia carrying member to indicate sponsorship or fan loyalties such as demonstrated by the indicia indicated at 36 in FIG. 10.

In light of the above, the present invention provides a sturdy, simply device that will provide a keyboard support device with the keyboard projecting at an angle of depression from the horizontal to provide a more natural use position for users. The keyboard support device of the present invention is also reversible so that at least two separate angles of depression may be attained from a single support device as will benefit an individual user.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

I claim:

1. A keyboard support device having a body, the body being formed with a first keyboard support surface and a second keyboard support surface disposed oppositely from the first keyboard support surface, and including a pair of elongate edges including a first elongate edge formed along the body and a second elongate edge formed along the body at a disposition oppositely from the first edge;
a first riser element operatively associated with the first elongate edge and projecting outwardly therefrom in a first direction for selective device support surface engagement to present the first keyboard support surface for use; and
a second riser element operatively associated with the second elongate edge and projecting outwardly therefrom in a second direction, the second direction being different from the first direction, for selective device support surface engagement to present the second keyboard support surface for use, wherein at least one of the first keyboard support surface and the second keyboard support surface extends at an angle of depression with respect to a horizontal plane extending tangentially to the upwardmost projection of one of the first keyboard support surface and the second keyboard support surface when the device is disposed on the device support surface for use.

2. A keyboard support device according to claim 1 wherein at least one of the first riser element and the second riser element is integrally formed with the body along at least one of the first edge and the second edge.

3. A keyboard support device according to claim 1 wherein at least one of the first riser element and the second riser element is integrally formed with the body along at least one of the first edge and the second edge thereby forming at least one of a first transition portion and a second transition portion.

4. A keyboard support device according to claim 1 wherein the first riser element and the second riser element extend in substantially opposite directions and extend in a generally parallel orientation.

5. A keyboard support device according to claim 1 wherein the first riser element extends away from the body in a first angular relationship therewith and the second riser element extends away from the body in a second angular relationship therewith, the first angular relationship being substantially similar with the second angular relationship.

6. A keyboard support device according to claim 1 wherein the first riser element extends away from the body in a first angular relationship therewith and the second riser element extends away from the body in a second angular relationship therewith, the first angular relationship being substantially different from the second angular relationship.

7. A keyboard support device according to claim 1 wherein the first riser element extends away from the body for a first predetermined length and the second riser element extends away from the body for a second predetermined length, the first predetermined length being the same as the second predetermined length.

8. A keyboard support device according to claim 1 wherein the first riser element extends away from the body for a first predetermined length and the second riser element extends away from the body for a second predetermined length, the first predetermined length being different from the second predetermined length.

9. A support device having a body, the body being formed with a first support surface and a second support surface disposed oppositely from the first support surface, and including a pair of elongate edges including a first elongate edge formed along one side of the body and a second elongate edge formed along the body at a disposition oppositely from the first edge;
a first upstanding support bar operatively associated with the first elongate edge and projecting outwardly therefrom in a first direction for selective support surface engagement to present the first support surface for use; and
a second upstanding support bar operatively associated with the second elongate edge and projecting outwardly therefrom in a second direction, the second direction being different from the first direction, for selective support surface engagement to present the second support surface for use wherein the first keyboard support surface and the second keyboard support surface extend at an angle of depression with a horizontal plane extending tangentially to the upwardmost projection of one of the first keyboard support surface and the second keyboard support surface when the device is disposed on the support surface for use.

10. A support device according to claim 9 wherein at least one of the first upstanding support bar and the second upstanding support bar is integrally formed with the body along at least one of the first edge and the second edge.

11. A support device according to claim 9 wherein at least one of the first upstanding support bar and the second upstanding support bar is integrally formed with the body along at least one of the first edge and the second edge thereby forming at least one of a first transition portion and a second transition portion.

12. A support device according to claim 9 wherein the first upstanding support bar and the second upstanding support bar extend in substantially opposite directions and extend in a generally parallel orientation.

13. A support device according to claim 9 wherein the first upstanding support bar extends away from the body in a first angular relationship therewith and the second upstanding support bar extends away from the body in a second angular relationship therewith, the first angular relationship being substantially similar with the second angular relationship.

14. A support device according to claim 9 wherein the first upstanding support bar extends away from the body in a first angular relationship therewith and the second upstanding support bar extends away from the body in a second angular relationship therewith, the first angular relationship being substantially different from the second angular relationship.

15. A support device according to claim 9 wherein the first upstanding support bar extends away from the body for a first predetermined length and the second upstanding support bar extends away from the body for a second predetermined length, the first predetermined length being the same as the second predetermined length.

16. A support device according to claim 9 wherein the first upstanding support bar extends away from the body for a first predetermined length and the second upstanding support bar extends away from the body for a second predetermined length, the first predetermined length being different from the second predetermined length.

17. A support device according to claim 9 wherein the support device is formed from a plastic material, with the plastic material being formed in at least one of several colors.

18. A support device according to claim 9 wherein at least one of the first support surface, the first riser element, the second support surface and the second riser element are formed as indicia carriers.

19. A method for supporting a control device including the steps of:
a. using a support device having a body, the body being formed with a first support surface and a second support surface disposed oppositely from the first support surface, and including a pair of elongate edges including a first elongate edge formed along one side of the body and a second elongate edge formed along the body at a disposition oppositely from the first edge;
a first upstanding support bar operatively associated with the first elongate edge and projecting outwardly therefrom in a first direction for selective support surface engagement to present the first support surface for use; and
a second upstanding support bar operatively associated with the second elongate edge and projecting outwardly therefrom in a second direction, the second direction being different from the first direction, for selective support surface engagement to present the second support surface for use, stand the body on a support surface, wherein the first keyboard support surface and the second keyboard support surface extend at an angle of depression with a horizontal plane extending tangentially to the upwardmost projection of one of the first keyboard support surface and the second keyboard support surface when the device is disposed on the support surface for use; and
b. placing the control device on one of the first support surface and the second support surface for positioning the control device at a first selected disposition for use thereof.

20. A method for supporting a control device according to claim 19 and further comprising the steps of:
a. removing the control device from at least one of the first support surface and the second support surface using a support device wherein the first upstanding support bar extends away from the body in a first angular relationship therewith and the second upstanding support bar extends away from the body in a second angular relationship therewith, the first angular relationship being substantially different from the second angular relationship;
b. inverting the support device to present the other of the first support surface and the second support surface for use; and
c. placing the control device on the other of the first support surface and the second support surface for positioning the control device at a second selected disposition for use thereof.

21. A method for supporting a control device according to claim 19 and further comprising the steps of:
a. removing the control device from at least one of the first support surface and the second support surface using a support device wherein the first upstanding support bar extends away from the body for a first predetermined length and the second upstanding support bar extends away from the body for a second predetermined length, the first predetermined length being different from the second predetermined length;
b. inverting the support device to present the other of the first support surface and the second support surface for use; and
c. placing the control device on the other of the first support surface and the second support surface for positioning the control device at a second selected disposition for use thereof.
